(19) United States
(12) Patent Application Publication
(10) Pub. No.: US 2019/0061648 A1
(43) Pub. Date: Feb. 28, 2019

(54) "Stop theft of all motor vehicles license plates"

(71) Applicant: RAYMOND THOMAS COUDRIET, ORLANDO, FL (US)

(72) Inventor: RAYMOND THOMAS COUDRIET, ORLANDO, FL (US)

(21) Appl. No.: 15/731,795

(22) Filed: Aug. 28, 2017

(51) Int. Cl. B60R 13/10; F16B 23/00; F16B 41/00

(52) U.S. Cl. CPC B60R 13/105; F16B 41/005; F16B 23/00

(57) ABSTRACT

License plates can no longer be stolen when this application is put into use. When the license plate is bolted into the vehicle plate holes using a smooth exterior round bolt with no slot on the head, the bolt is secured and cannot be removed from the exterior of the vehicle.

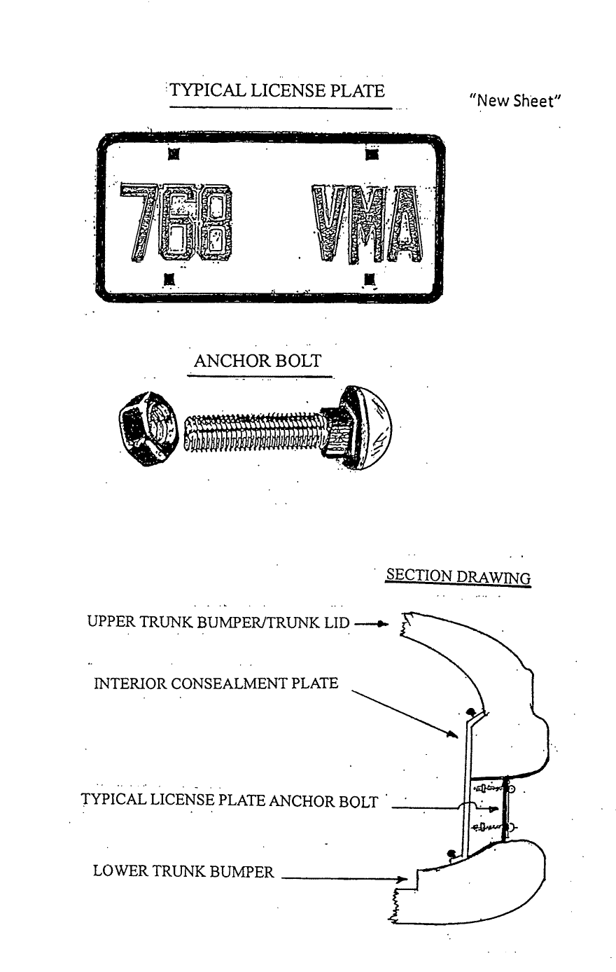

Use ⅝″ round headed stainless steel screws that are bolted when extended into the trunk area. That area is covered with material that conceals the steel frame of the trunk, just as it is currently today.

THE ROUND HEADED BOLTS MEAN YOU CAN'T UNSCREW THE LICENSE PLATE.

### CROSS-REFERENCE TO RELATED APPLICATIONS

NOT APPLICABLE.

### STATEMENT REGARDING FEDERALLY SPONSORED RESEARCH OR DEVELOPMENT

NOT APPLICABLE.

### THE NAMES OF THE PARTIES TO A JOINT RESEARCH ASSIGNMENT

NOT APPLICABLE.

### INCORPORATION-BY-REFERENCE OF MATERIAL SUBMITTED ON COMPACT DISC OR AS A TEXT FILE VIA THE OFFICE ELECTRONIC FILING SYSTEM (EFS-WEB) NOT APPLICABLE.

### STATEMENT REGARDING PRIOR DISCLOSURES BY THE INVENTOR OR A JOINT INVENTOR

NOT APPLICABLE.

### BACKGROUND OF THE INVENTION

THE NEED TO KEEP LAW ENFORCEMENT SAFER.

### (1) Field of Invention

TO FIND A SOLUTION FOR LAW ENFORCEMENT REGARDING STOLEN PLATES AND RELATED CRIMES.

### (2) Description of Related Art including information disclosed under 37 CFR 1.97 and 1.98

NOT APPLICABLE.

### BRIEF SUMMARY OF THE INVENTION

IT WILL MORE DIFFICULT TO STEAL VEHICLE LICENSE PLATES.

### BRIEF DESCRIPTION OF THE ONE VIEW OF THE DRAWING

SHOWS PROCESS OF ATTACHMENT, ON THE INSIDE OF THE TRUNK.

### DETAILED DESCRIPTION OF THE ONE VIEW OF THE DRAWING

IT STOPS A SCREWDRIVER OR ANOTHER DEVISE FROM REMOVING A LICENSE PLATE FROM A VEHICLE UNLESS YOU OPEN THE TRUNK FIRST, AND REMOVE THE BOLT ON SCREW FROM THE INSIDE.

### CLAIM

LISTED ON SEPARATE SHEET.

### ABSTRACT OF THE DISCLOSURE

DISCLOSURE SHOWS THE DIFFICULTIES IN TRYING TO STEAL A VEHICLE LICENSE PLATE.

### SEQUENCE LISTING

NOT APPLICABLE.

1. VEHICLE LICENSE PLATES WOULD BE INSTALLED WITH ROUND HEADED BOLTS. THEY NO LONGER CAN BE STOLEN IN A FEW MINUTES. THESE BOLTS GO ALL THE WAY INTO THE TRUNK. THEY WOULD REQUIRE PRYING THE TRUNK OPEN, THEN REMOVAL OF DECORATIVE LINING MATERIAL, THEN HAVING THE RIGHT SIZE WRENCH TO TRY TO REMOVE THE PLATE, MEANWHILE, THE ALARM IS SOUNDING AND ALERTING EVERYONE.
